(19) United States
(12) Patent Application Publication
(10) Pub. No.: US 2015/0341713 A1
(43) Pub. Date: Nov. 26, 2015

(54) VOICE STICKER STRUCTURE

(71) Applicant: I-LIN TSAI, Tainan City (TW)

(72) Inventor: I-LIN TSAI, Tainan City (TW)

(21) Appl. No.: 14/287,034

(22) Filed: May 25, 2014

(51) Int. Cl. H04R 1/02; G09B 5/04; G09B 21/00; G09B 19/00

(52) U.S. Cl. CPC H04R 1/028; G09B 19/00; G09B 5/04; G09B 21/006

(57) ABSTRACT

A voice sticker structure comprises a sticker body and a control unit disposed inside the sticker body. The sticker body may be in various forms, with its back covered with a glue material. The control unit includes at least a microcontroller and coupled to the microcontroller are a sounding element, a sound pickup element, a press button, a battery, a volume adjustment knob, and a slot for plugging an external storage unit in. In the microcontroller are stored voice materials of words, phrases, and short sentences. The sticker body may be stuck on any object or at any place, and when the sticker body is pressed it plays sounds of words or phrases to facilitate language learning anywhere anytime. A voice sticker with a slot allows changing of memory cards with different voice materials to meet different needs and facilitate different stages of language learning, cognitive learning, and children character education, or to provide guides to activities or objects, description of products, voice services for the visually impaired or the illiterate, and language services for non-native people. To meet the above needs, the voice sticker also allows inputting of voices via a sound pickup element to be stored in a storage unit and to be played when the voice sticker is pressed. It can also serve as a reminder of pending tasks in place of pen and paper.

### BACKGROUND OF THE INVENTION

1. Field of the Invention

The present invention relates to a voice sticker structure, particularly to a voice sticker structure which may be stuck on any object or at any place and which may play sounds of words, phrases, short passages, or summaries when pressed anywhere anytime, so as to facilitate language learning, cognitive learning, and children character education, or to provide guides or instructions to activities or objects, descriptions of products, voice services for the visually impaired or the illiterate, and language services for non-native people, or to allow inputting of voices via a sound pickup element to be stored in a storage unit and, when the sticker is pressed, to be played as a reminder of pending tasks in place of pen and paper.

2. Description of Related Art

Existent stickers are stuck on objects without any additional functions. With the advancement of technology, there are currently on the market various language learning materials available for young and even adult learners of languages, which usually include books and accompanying voice pens or CDs. Therefore in the process of learning, both a book and its assorted voice devices are required. Not only is this inconvenient, but it prevents the learner from performing other tasks at the same time. Learning cannot be easily achieved anytime and anywhere, so the learner's motivation to learn is gradually damped down. In addition, on museum or art gallery visits, one misses a lot if one fails to understand written guides, introductions, or comments due to one's poor eyesight or poor literacy level. It is also a great pity when time limit does not allow one to read those guides, introductions, or comments. In view of this, after laborious research and experiments, the applicant has devised a voice sticker structure to address the above-mentioned issues and to facilitate language learning, provide descriptions of products, and serve as a reminder of pending tasks in place of pen and paper.

### SUMMARY OF THE INVENTION

It is an object of the present invention to provide a voice sticker structure to be stuck on any object or at any place which may play sounds of words or phrases when pressed anywhere anytime, so as to facilitate language learning, cognitive learning, and children character education, or to provide guides or instructions to activities or objects, descriptions of products, voice services for the visually impaired or the illiterate, and language services for non-native people, or to allow inputting of voices via a sound pickup element to be stored in a storage unit and to be played as a reminder of pending tasks when the sticker is pressed in place of pen and paper.

The foregoing voice sticker structure includes a sticker body and a control unit disposed inside the sticker body. The sticker body may be in various forms, with its back covered with a glue material. The control unit includes at least a microcontroller and coupled to the microcontroller are a sounding element, a sound pickup element, a press button, a battery, a volume adjustment knob, and a storage unit. In the microcontroller are stored voice materials of words and phrases. The sticker body may be stuck on any object or at any place, and when the sticker body is pressed it plays sounds of words or phrases to facilitate language learning anywhere anytime. It allows inputting of voices via a sound pickup element to be stored in a storage unit and, when the sticker is pressed, to be played as a reminder of pending tasks in place of pen and paper. It also provides voice services or guides to products, activities, or objects for the visually impaired, the illiterate or non-native people.

The fore-going voice sticker structure, wherein the storage unit is an R/W external memory card.

### BRIEF DESCRIPTION OF THE INVENTION

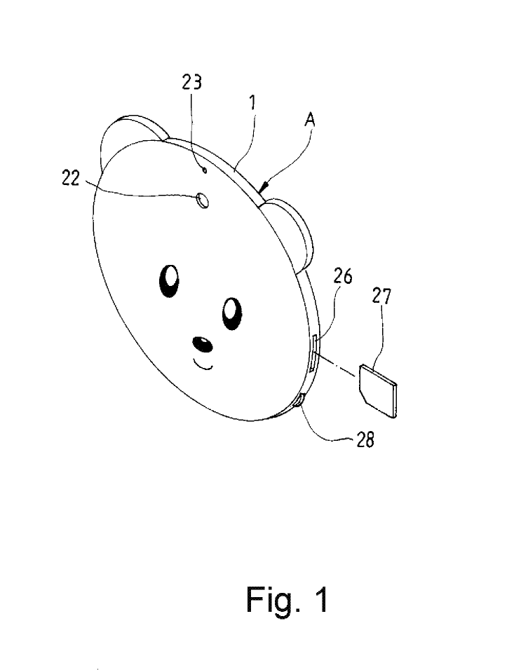

FIG. 1 is a pictorial drawing of the present invention;

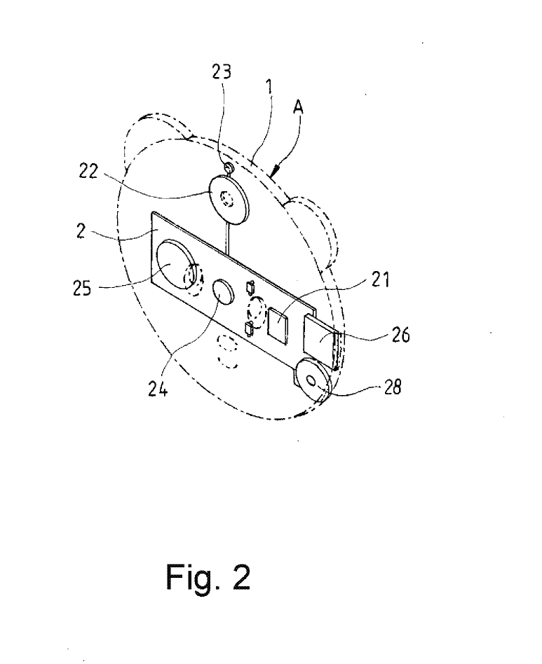

FIG. 2 is a structure diagram of the present invention;

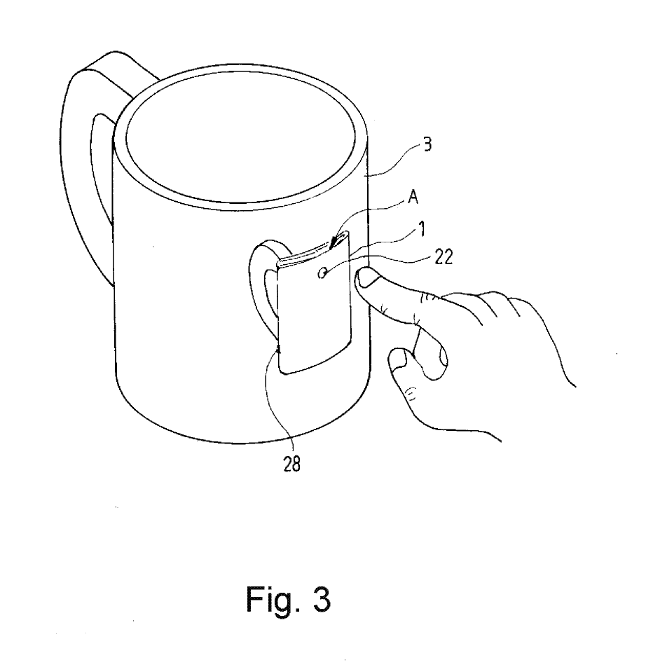

FIG. 3 is a drawing of the present invention in use;

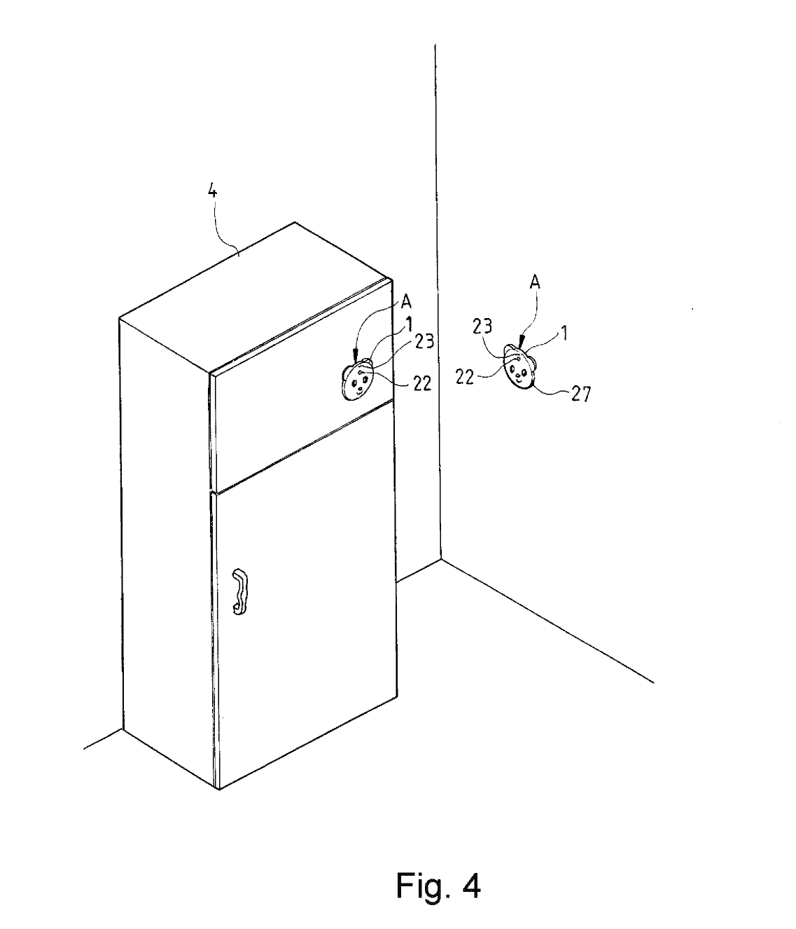

FIG. 4 is another drawing of the present invention in use;

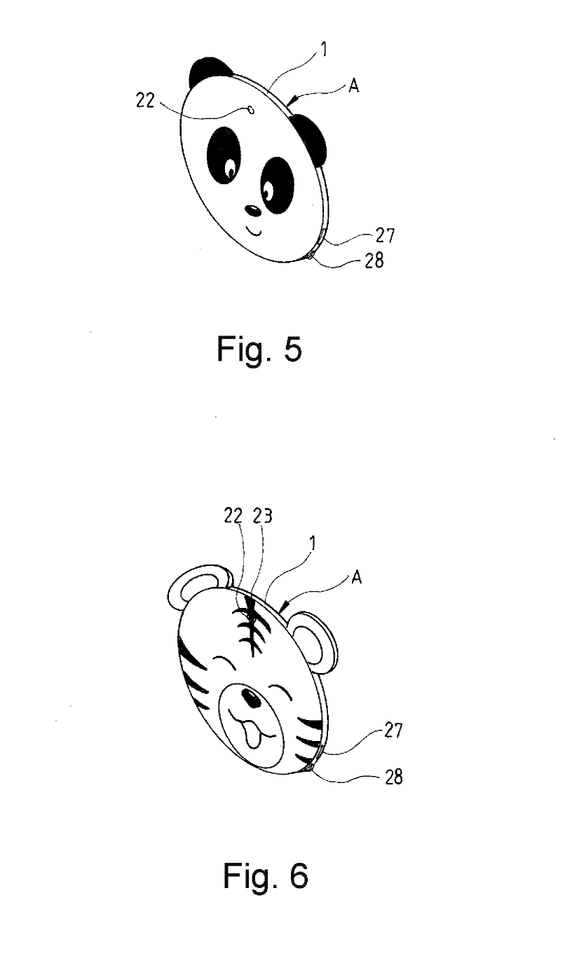

FIG. 5 is a pictorial drawing of another preferred embodiment of the present invention;

FIG. 6 is a pictorial drawing of yet another preferred embodiment of the present invention;

### DETAILED DESCRIPTION OF THE PREFERRED EMBODIMENT

Please refer to both FIG. 1 and FIG. 2, respectively a pictorial drawing and a structure diagram of the present invention. As shown in the figures, the present invention includes a sticker body 1 and a control unit 2 disposed inside the sticker body 1. The sticker body 1 may be in various forms (adorable mascots or fashionable designs) with its back covered with a glue material, and release paper is stuck to the glue material. The control unit 2 includes at least a microcontroller 21 and coupled to the microcontroller 21 are a sounding element 22 (a super thin flat speaker), a sound pickup element 23 (a miniature microphone), a press button 24, a battery 25 (a thin button battery), a slot 26, a storage unit 27 to be plugged into the slot 26, wherein voice materials of words and phrases are stored in the microcontroller 21 and wherein the storage unit 27 is an R/W external memory card (such as an SD card). A volume adjustment knob 28 may also be disposed in the present invention for volume adjustment.

The combination of the fore-going parts forms a voice sticker A. When in use, the release paper at the back of the sticker is ripped off and the voice sticker A is stuck on any object or at any place. When the voice sticker A is pressed, it plays the sounds of words or phrases via the sounding element 22 for language learning anywhere anytime; the volume may be adjusted by the volume adjustment knob 28. Or, voices may be input via the sound pickup element 23 to be stored in the storage unit 27 and to be played when the voice sticker A is pressed for reminding pending tasks. The storage unit 27 may be replaceable to allow changing to various learning materials and thus broaden the range of language learning, for example Stage 1, Stage 2, Elementary Level, intermediate Level, and Advanced Level, etc. Or, the voice sticker may provide guides to activities, objects, or products in place of a human guide.

Please refer to FIG. 3, showing the present invention in use. Please also refer to FIG. 2. As shown in the figures, the voice sticker A of the present invention may be stuck on any object or at any place. When the voice sticker A is pressed, it plays sounds of words or phrases to facilitate language learning anywhere anytime. In this preferred embodiment of the present invention, the sound of the English (or Japanese, German, French, and other languages) word CUP is stored in the microcontroller 22. The user may stick the voice sticker A in the form of a cup to a cup 3. When a young or adult learner of English is using the cup 3, he or she may press the press button 24 in the voice sticker A to activate the microcontroller 21 so that the sounding element 22 play sounds of the word CUP for repeated listening. The volume may be adjusted via the volume adjustment knob 28. The present invention associates the word CUP with the real cup to reinforce the learner's memory through pictorial learning (visual stimulation), physical contact (sensory stimulation), and voice learning (auditory stimulation), thus creating a native-like environment for situated learning to improve language learning results. For instance, a voice sticker A in the form of a table which plays the sound of the word TABLE may be stuck to a table. A phrase or a sentence, such as “this is a cup”, may also be stored in the microcontroller 21 for the learner to learn a phrase or a dialogue. In addition, in the microcontroller 21 may also be stored operation instructions, descriptions, remarks, or suggestions of products, activities or objects, to provide guides, introductions, or comments in government sectors, museums, art galleries, or privately-owned restaurants. It may also provide introductions and guides in various languages for non-native people and the visually impaired.

Please refer to FIG. 4, showing another preferred embodiment of the present invention in use. Please refer also to FIG. 2. As shown in the figures, the voice sticker A of the present invention may be stuck on any object or at any place. When the voice sticker A is pressed, it plays sounds of words or phrases to facilitate language learning anywhere anytime. In this preferred embodiment, the voice sticker A may be stuck on a refrigerator 4. When the learner presses the voice sticker A. the sounding element 22 sounds the word REFRIGERATOR for repeated listening. In another preferred embodiment, the voice sticker A may serve as a reminder of pending tasks in place of pen and paper. In this preferred embodiment, the voice sticker A on the refrigerator 4 or on a wall is pressed for a while (around 3 seconds) and the sound pickup element 23 inputs sounds to be stored in the storage unit 27 and to be played as a reminder of pending tasks in place of pen and paper. For instance, the message may be “beef in the refrigerator was purchased on a certain date and the expiration date is on a certain date”, or “go to a certain company on business tomorrow morning”, etc. The voice sticker may replace the conventional way of taking notes on a notebook and leaving through notes for important information.

Please refer to FIG. 5, showing another preferred embodiment of the present invention. Please also refer to FIG. 2. As shown in the figures, the voice sticker A of the present invention may be in various forms. For instance, in this preferred embodiment, the voice sticker A is designed as an adorable panda to attract young children's attention, so that young children would continue to press the voice sticker A and listen to the sounds played via the microcontroller 21 or the storage unit 27. This kind of constant exposure facilitates language learning, training of everyday disciplines, character education, or learning about the habitual behavior of the animal (mascot).

Please refer to FIG. 6. a pictorial drawing of yet another preferred embodiment of the present invention. As shown in the figure, the voice sticker A of the present invention may be in various forms. For instance, in this preferred embodiment, the voice sticker A is designed as an adorable cartoon tiger to attract young children's attention, so that young children would repeatedly press the voice sticker A and listen to short educational stories coming from the voice sticker A. This kind of constant exposure facilitates language learning, training of everyday disciplines, character education, or learning about the habitual behavior of an animal (mascot). In addition, the voice sticker A may also serve as a reminder of pending tasks in place of pen and paper.

The fore-going preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing considerations, the present invention relates to voice sticker structure comprising a self-adhesive sticker body and a control unit disposed inside the sticker body, which may be stuck on any object or at any place and which may play sounds of words, phrases, short passages, or summaries when pressed anywhere anytime, so as to facilitate language learning, cognitive learning, and children character education, or to provide guides or instructions to activities or objects, descriptions of products, voice services for the visually impaired or the illiterate, and language services for non-native people, or to allow inputting of voices via a sound pickup element to be stored in a storage unit and, when the sticker is pressed, to be played as a reminder of pending tasks in place of pen and paper.

What is claimed is:

1. A voice sticker structure, comprising:
a sticker body, which may be in various forms, with its hack covered with a glue material;
a control unit disposed inside the sticker body, comprising at least a microcontroller and coupled to the microcontroller are a sounding element, a sound pickup element, a press button, a volume adjustment knob, a battery, a slot, and a storage unit to be plugged in the slot; and in the microcontroller are stored voice materials of words, phrases, short passages, or summaries;
wherein the voice sticker structure may be stuck on any object or at any place; and wherein when the voice sticker is pressed, it plays the voice materials of words, phrases, short passages, or summaries, so as to facilitate language learning, cognitive learning, and children character education, or to provide guides or instructions to activities or objects, descriptions of products, voice services for the visually impaired or the illiterate, and language services for non-native people; or to allow inputting of voices via a sound pickup element to be stored in a storage unit and to be played as a reminder of pending tasks when the sticker is pressed.

2. The voice sticker structure of claim 1, wherein the storage unit is an R/W external memory card.

3. The voice sticker structure of claim 1, wherein the sounding element is a super-thin flat speaker.
